(19) United States
(12) Patent Application Publication
(10) Pub. No.: US 2016/0161079 A1
(43) Pub. Date: Jun. 9, 2016

(54) 3D-EFFECT LED ILLUMINATING DEVICE WITH SCATTERING SYSTEM

(71) Applicant: AUTOMOTIVE LIGHTING REAR LAMPS FRANCE, Saint-Julien-du-Sault (FR)

(72) Inventor: Alain Buisson, Trappes (FR)

(21) Appl. No.: 14/787,494

(22) PCT Filed: Apr. 30, 2014
(86) PCT No.: PCT/FR2014/051044

§ 371 Date: Feb. 1, 2016

(30) Foreign Application Priority Data
Apr. 30, 2013 (FR) 1301009

(51) Int. Cl. F21S 8/10

(52) U.S. Cl. CPC F21S 48/215; F21S 48/2206; F21S 48/234

(57) ABSTRACT

Illuminating device, especially for an automotive vehicle. It comprises a combination of means essentially composed of: a) substantially perpendicular to the LEDs (5), in front of the illuminating face of the LEDs, a system comprising opaque parallel plates (1, 2) at least one of the faces of which is a light colour, preferably a white colour, •at least two of said parallel plates defining a channel at the bottom of which said LEDs are distributed, and •said wall-forming plates being arranged substantially perpendicular to the midplane of said PCB so as to channel the light emitted by said LEDs, and •the at least one light- or white-coloured face of said plates being turned towards the interior of said channel; and (b) near the frontal end of said channel, level with said end or preferably upstream of said end, a substantially planar reflector (7), and downstream from the latter, in the direction of light emission/transmission in operation, a semi-transparent screen (8) substantially parallel to said reflector, comprising, on at least one of its two main faces, elements promoting the dispersion of the incident light.

The present invention relates to the field of illumination and signalling, especially for automotive vehicles. It relates more particularly to an illumination or signalling device having a plurality of LEDS as light sources, and wherein the spatial scattering of the light emitted is enhanced, whereas the scattered light further provides a three-dimensional effect at the output thereof from the device. Such a device may be especially used as a signal light, indicator, both at the rear and the front of the vehicle, or as a position light or stop light.

The current regulations require, according to the types of vehicles, various illumination or signal lamps. However, besides the volume of the set of lights, the performances and uniformity of illumination of the individual lights grouped in this manner are major concerns.

Transparent auxiliary screens are already known in the prior art, wherein the light emitted by an auxiliary light source can be propagated, these screens being intended to equip a light, especially a rear light, of an automotive vehicle. Local discontinuities provided in the screen material form light scattering focal points from these screens (see French patent publication No. 2 868 506).

In the German patent application DE 101 01 795, indicator lights are described, especially front indicator lights for automotive vehicles, wherein an auxiliary light source for a position light illuminates an element arranged transversally in the space between the main light and the front cover, and provides thereby illumination in the same direction as that of the main light.

In the French patent application 01 00048, published under the number 2 819 040, an optical or styling component for the illumination or signalling of automotive vehicles is described. This component is made of transparent material, inside which light scattering focal points are situated only at predetermined locations in order to scatter the light emitted by a source associated with the illumination or signalling device in question. This component may constitute the cover of an automotive vehicle lamp, or an insert placed in such a lamp.

In the German patent application DE 103 11 317, a vehicle illumination device is described, comprising a light guide including scattering structures situated essentially at the focal point of reflective surfaces which thus allow scattering of homogeneous illumination.

The applicant has also designed, and described in the patent application FR 0905984 published under the No. 2953781, a novel device for an automotive vehicle light, comprising a transparent optical material and at least one LED type light source arranged to emit light rays propagated inside the thickness of said transparent optical material, essentially comprising:
a plate of a transparent optical material forming a curtain,
said plate comprising at least one bilateral elongated bulge, having a substantially circular overall cross section, having the median longitudinal axis in the midplane of said plate and suitable for forming a light guide, and
at least one LED placed at at least one of the ends of said light guide, with the main axis thereof orthogonal to the longitudinal axis of said light guide.

In these various applications and these various embodiments of light screens scattering the light emitted by at least one LED, inhomogeneities in the scattered light may appear, particularly at the guides with which the curtains or scattering screens may be equipped.

In the case of direct illumination by high- or medium-power LEDs, it is now recognised that it is blinding and should not be generalised in this form.

The applicant further described in the patent application FR 1200281 dated 31.01.2012 an LED illumination device arranged to provide a scattering system helping ensure the uniformity of the light rendition of advantageously multi-LED illumination.

It then appeared to be useful to seek to ensure the uniformity of the light rendition of illumination and signalling devices, and/or to mask any inhomogeneities, and also to provide such devices with a three-dimensional effect enabling personalisation of the light effect and optionally styling effects.

The present invention is intended to provide means for supplying illumination having such a homogeneous rendition and offering users a much less tiring or less blinding rendition than the LED illuminations currently on the market, at the same time that said means are arranged to provide a three-dimensional effect or depth effect for subjects located in the illumination field of the device equipped with said means.

The novel illumination device according to the invention, especially intended, but without being limiting, for a signal lamp and/or exterior or interior ambiance illumination of the passenger compartment of automotive vehicles, comprises a combination of means essentially composed of:
(a) at least one LED, preferably a plurality of LEDs distributed along a line of any shape on a printed circuit board (abbreviated to PCB),
substantially perpendicular to said at least one LED, in front of the illuminating face of the LED, a system comprising opaque parallel plates, at least one of the faces of which is a light colour, preferably a white colour,
at least two of said parallel plates bearing on the PCB and/or on the periphery thereof, respectively on either side of at least one LED borne by said PCB, so as to define a channel at the bottom of which said LEDs are distributed, and said plates forming a wall being arranged substantially perpendicular to the midplane of said PCT so as to channel the light emitted by said LEDs, which escapes from said device via the side of said plates opposite the side mentioned above bearing on or around the PCB, and
the at least one light- or white-coloured face of said plates being turned towards the interior of said channel,
and
(b) near the front end of said channel, level with said end or preferably upstream thereof in the direction of light emission output in operation, a substantially planar reflector (7) and, downstream thereof, in the direction of light emission/scattering in operation, a semi-transparent screen (8) substantially parallel to said reflector and comprising, on at least one of the two main faces thereof, elements promoting the dispersion of the incident light,
whereas said reflector is mounted and only extends inside the surface defined by the profile of the inner periphery of the output end of said channel, and
whereas said semi-transparent screen has a profile facing said reflector, at a distance therefrom and is of a larger size such that it further substantially covers the output end of said channel.

Although the device according to the invention may be of any shape and size, it will be described hereinafter with reference to a device forming an illumination, marking and/or signalling light for automotive vehicles, and with reference to an example of an embodiment wherein said opaque walls are hollow cylinder sections, two in number, having respective radii R and r, arranged parallel to one another, concentrically, and bearing on a PCB whereon n LEDs are placed, regularly or irregularly spaced from one another, whereas said LEDs are arranged so as to emit a light beam directed substantially diametrically in the passage of width R-r thus defined by said opaque plates.

In practice, the opaque walls may define an annular channel or passage of not only circular shape, but also quadrangular, polygonal, or other shapes, regular or not, or a linear or sinuous channel. In the latter case, the walls have identical or homothetic curves, having alternating directions of curvature and with intercalated planar portions.

In one preferred embodiment, the LEDs are arranged substantially regularly according to a geometric figure such as, for example, a circle, on a PCB type substrate.

The elements (b) of said combination of means combine the effects thereof with those of part (a) to provide the particularly attractive effects in terms equally of light intensity and contour precision and originality of the styling effects enabled.

The invention will be understood better, and further aims, advantages and features thereof will emerge more clearly in the light of the description detailed hereinafter of an embodiment considered to be an illustrative example, and alternative or optional embodiments.

The device according to the invention provides the best results thereof in terms of scattering and dispersion of the light from the LEDs when the LEDs or PCB bearing the LEDs are placed at an angle between 0 and approximately 20°, and preferably in an angle of approximately 15°, relative to the transverse section plane of said plates forming a channel for the light from the LEDs.

It was observed that, as such, the light emitted by the LEDs is reflected on the inner walls of the channel defined between two opaque plates and is scattered/dispersed before being routed to the output of the channel from which it is visible by an observer suitably placed in a suitable field of vision.

In addition, the three-dimensional effect provided is permanent, i.e. it appears to the human eye even when the LEDs in question are not switched on. This thus makes it possible to obtain advantageously and economically a 3D effect for the image of the illumination device in question, even when said device is not illuminated, in daylight.

The embodiments described hereinafter are provided merely for illustrative and non-limiting purposes, particularly with reference to the sheets of drawings appended wherein:

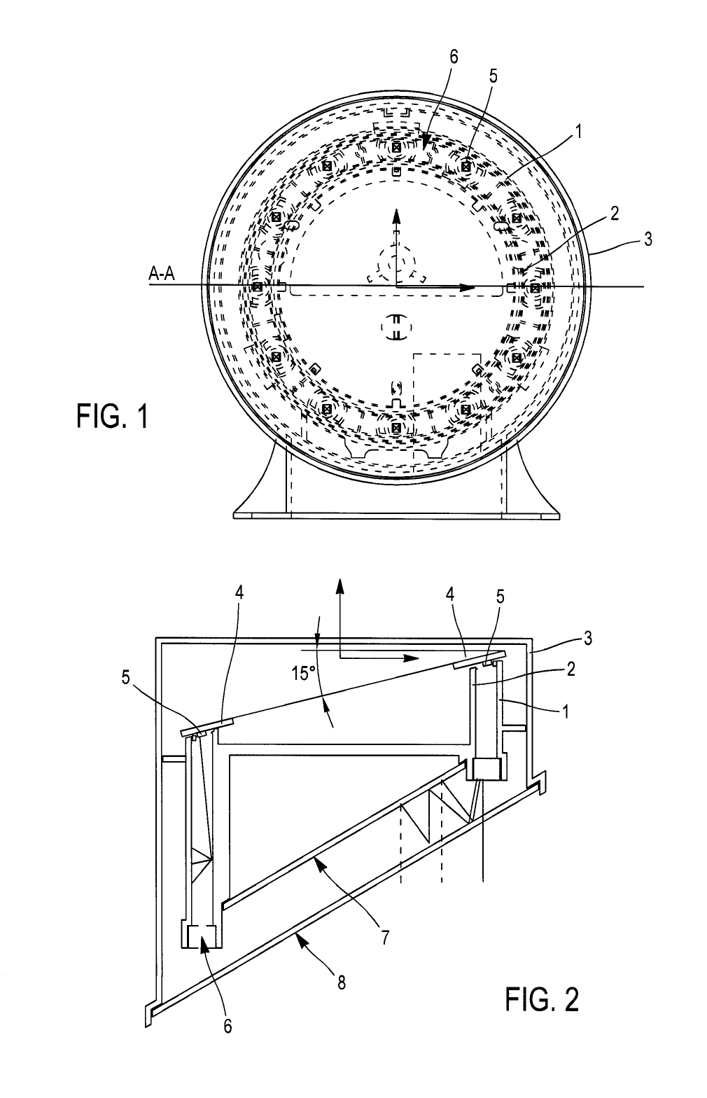

FIG. 1 represents a schematic front view, in elevation, of an illumination device according to the invention, on a base; and

FIG. 2 represents a schematic transverse section view along A-A of the illumination device according to FIG. 1.

As shown in FIGS. 1 and 2 in the embodiment represented therein, the illumination device according to the invention may comprise a system of concentric tubes 1, 2 suitably mounted inside a housing 3, and mounted on a base in the illustrative example shown. In practice, the base may be a bodywork or structural element of an automotive vehicle, for example.

In the bottom of said housing, a printed circuit board (PCB) 4 comprising LEDs 5 is placed.

In order to be operational, such a device is arranged to be connected to a suitable electric current source.

As can be seen according to FIG. 2, the LEDs are advantageously arranged at an angle, for example approximately 15°, relative to the transversal plane of the walls forming a channel. The light beam thereof is thus reflected a maximum number of times on the walls of said ring.

An identical or similar angle may be recommended, but is not necessary for the midplane of the reflector 7 and the semi-transparent screen 8 mentioned above.

Optionally, said reflector or mirror may comprise a reserve (not shown), i.e. a portion of transparent or perforated surface, situated facing at least one LED for the stop function and/or indicator function or reverse light. However, such a reserve is not necessary in the device according to the present invention.

The semi-transparent screen may, to its part, comprise a reserve facing each of the beams from the LEDs or merely facing some thereof.

Provided that the cooling of the LEDs via the rear face thereof is not impeded, and is even advantageously favoured by suitable means known to those skilled in the art, the modular device according to the invention has the remarkable advantage of being capable of being designed so as to be extremely compact and efficient.

The device according to the present invention may comprise, separately or in combination, optional or alternative features, such as in particular:
the LED PCB has a circular geometry, with the n LEDs (where n is an integer from 4 to 20, preferably equal to 12) arranged on the periphery thereof, preferably at substantially identical distances between two consecutive LEDs;
the LEDs are mounted on a PCB, on the front face whereof, said tube is arranged in front of said LED PCB, advantageously such that the longitudinal axis thereof is perpendicular to the plane of said PCB;
at least the inner face of the opaque plates consists of a white or similar coloured material and/or is lined with a white or similar coloured coating;
said inner face of the opaque plates, i.e. the face facing the inside of the channel defined thereby for the LEDs in question, is preferably covered with rough areas. Such a rough wall disperses the light from the LEDs better;
to compensate for the fact that a small portion of the light beam from the LEDs is attenuated or lost by undesired reflections or reflections not reaching the output of the channel, it is envisaged to use LEDs having a higher maximum light flux than the LEDs currently used in devices not provided with this light channelling, for example by replacing 20 lumen LEDs by 40 lumen LEDs;
the ratio of the length to the diameter of said tube (excluding the bulging end portion) is situated advantageously in the interval from 3 to 10, preferably from 4 to 7, and more preferably of approximately 5;
the width of the channel between two parallel opaque plates is preferably approximately 10 to 15 mm;
the light emission axis is advantageously parallel to the axis conventionally referred to as the X axis of the vehicle;
the mounting of said channelling system in the axis of the main beam from said LEDs is performed by means of a suitable mounting on the wall of a circular module bearing said n LEDs;
said LED-bearing module may have a front face wherein the main plane is slanted in relation to the longitudinal axis of said tubular system;
the supply of the LED PCBs with electric current is performed by conventional means, known to those skilled in the art;
the illumination housing further comprises a transparent glass pane on the front face thereof;
means for a stop function with no 3D effect may be envisaged in addition to or instead of the means for a stop function with a 3D effect, to further enhance safety in terms of stop signals;
the presence of reserves may be sought, in that it may provide, at the locations and in the functions for which mention is made thereof, a higher light intensity and that it provides more flexibility to the assembly by helping maintain the illumination of the function in question above the specification concerning same, even in the event of failure of an LED.

An end flare 6 of said tubes is optional; it makes it possible to increase the width and the brightness of the beam leaving said tube, and thus give said beam of light rays leaving said tube a width along with exceptional homogeneity, unusual in the current state of the knowledge of those skilled in the art and embodiments that this may infer.

The diameter of said module may be situated, for example, between approximately 10 and 15 centimetres for a main illumination device, such as for example a rear light of an automotive vehicle.

The device according to the invention thus provides the human eye with a view with motion effect comparable to that obtained using the hologram technique, now well-known. It provides a 3D effect with the semi-transparent screen belonging to the sub-assembly (b), and also a styling effect even when the light in question is switched off.

A further aim of the invention consists of an automotive vehicle equipped with at least one device as described herein.

In such a device, the LEDs emit rays which are essentially reflected onto the inner wall of said tubes; after successive reflections of the same light ray, said ray has acquired a beam width and homogeneity means that it provides, for the human eye situated facing the output of said tubes, luminous radiation that remains powerful, but is markedly more homogeneous and less blinding than the radiation originally emitted by the same LED assembly not equipped with the device according to the invention.

For applications in the automotive sector, those skilled in the art will understand that the device according to the invention is positioned in practice at the usual locations of automotive vehicle bodywork. More generally, said device may also be used, with suitable size and configuration adaptations, inside the passenger compartment of automotive vehicles, and even more generally for all household or professional usages, at any location where illumination enhanced in this way by a device according to the invention is sought.

1. Illumination device, especially for an automotive vehicle, comprising LEDs, advantageously mounted on a printed circuit board or PCB, characterised in that it comprises a combination of means essentially composed of:
(a) in front of the illuminating face of the LEDs, a system comprising opaque parallel plates (1, 2) at least one of the faces of which is a light colour, preferably a white colour, substantially perpendicular to the LEDs (5), whereas the opaque plates (1, 2) define an annular channel or passage having a circular, quadrangular, polygonal shape, regular or not, or a linear or sinuous channel, and advantageously a set of concentric tubes, and
whereas the LEDs (5) or the PCB (4) bearing the LEDs (5) are placed at an angle of up to approximately 20°, and preferably approximately 15°, relative to the transverse section plane of said plates forming a channel for the light from said LEDs,
at least two of said parallel plates bearing on the PCB (4) and/or on the periphery thereof, respectively on either side of at least one LED borne by said PCB, so as to define a channel at the bottom of which said LEDs are distributed, and
said plates forming a wall being arranged substantially perpendicular to the midplane of said PCB so as to channel the light emitted by said LEDs, which escapes from said device via the side of said plates opposite the side mentioned above bearing on or around the PCB, and
the at least one light- or white-coloured face of said plates being turned towards the interior of said channel, and
(b) near the front end of said channel, level with said end or preferably upstream thereof in the direction of light emission output in operation, a substantially planar reflector (7) and, downstream thereof in the direction of light emission/scattering in operation, a semi-transparent screen (8), substantially parallel to said reflector and comprising, on at least one of the two main faces thereof, elements promoting the dispersion of the incident light,
whereas said reflector is mounted and only extends inside the surface defined by the profile of the inner periphery of the output end of said channel, and whereas said semi-transparent screen has a profile facing said reflector, at a distance therefrom and is of a larger size such that it further substantially covers the output end of said channel.

2. Device according to claim 1, characterised in that it further comprises an area of greater width or flared area at the free end of said channel, whereby the light emitted by the LEDs (5) when the LEDs are switched on is output from the device.

3. Device according to any of claim 1 or 2, characterised in that the opaque walls (1, 2) are hollow cylinder sections, two in number, having respective radii R and r, arranged parallel to one another, concentrically, and bearing on a PCB (4) whereon n LEDs (5) are placed, regularly or irregularly spaced from one another, whereas said LEDs are arranged so as to emit a light beam directed substantially diametrically in the passage of width R-r thus defined by said opaque plates.

4. Device according to claim 1, characterised in that said concentric tubes are mounted inside a housing (3).

5. Device according to any of claims 1 to 4, characterised in that the LEDs (5) are mounted on a PCB (4), on the front face of which said channel is formed is arranged in front of said LED PCB, advantageously such that said PCB is substantially inclined by approximately 15° relative to the longitudinal axis of said tube.

6. Device according to any of claims 1 to 5, characterised in that the LED (5) PCB (4) has a circular geometry, whereas the n LEDs, where n is an integer from 4 to 20, preferably equal to 12, are arranged on the periphery thereof, preferably at substantially identical distances between two consecutive LEDs (5).

7. Device according to any of claims 1 to 6, characterised in that the face of the opaque plates (1, 2) facing the inside of said channel is covered with rough areas.

8. Device according to any of claims 4 to 7, characterised in that it further comprises an end flare (6) of said tubes, so as to increase the width and brightness of the beam of light rays leaving said tube.

9. Device according to any of claims 1 to 8, characterised in that said reflector and said semi-transparent screen are substantially inclined by approximately 15° relative to the longitudinal axis of said tube.

10. Device according to any of claims 1 to 9, characterised in that said device comprises, near the front end of said channel, level with said end or preferably upstream thereof in the direction of light emission output in operation, a substantially planar reflector (6) and, downstream thereof in the direction of light emission/scattering in operation, a semi-transparent screen (7) substantially parallel to said reflector and comprising, on at least one of the two main faces thereof, elements promoting the dispersion of the incident light,
whereas said reflector is mounted and only extends inside the surface defined by the profile of the inner periphery of the output end of said channel, and
whereas said semi-transparent screen has a profile facing said reflector, at a distance therefrom and is of a larger size such that it further substantially covers the output end of said channel.
